(19) United States
(12) Patent Application Publication
(10) Pub. No.: US 2011/0018906 A1
(43) Pub. Date: Jan. 27, 2011

(54) ELECTROLUMINESCENT BACKLIGHT DRIVING CIRCUIT

(76) Inventor: Sen-Fu Chiu, Yangmei Taoyuan (TW)

Correspondence Address: Muncy, Geissler, Olds & Lowe, PLLC, 4000 Legato Road, Suite 310, FAIRFAX, VA, 22033, US

(21) Appl. No.: 12/509,238

(22) Filed: Jul. 24, 2009

(51) Int. Cl. G09G 5/10; G09G 3/30; G09G 3/36

(52) U.S. Cl. 345/690; 345/77; 345/102

(57) ABSTRACT

An electroluminescent (EL) backlight driving circuit is compatible with current display control circuit, and includes a power on/off unit controlled by an ON signal of the display to output the power supply of the display as a working voltage; a boost unit for boosting the working voltage to a modulation working voltage; a resonance unit for oscillating the modulation working voltage to generate an AC working voltage for driving an electroluminescent (EL) panel to emit light and serve as the backlight source of the display; and a voltage feedback unit for comparing an output feedback voltage of the resonance unit with a brightness signal of the display and then with a feedback control voltage of the boost unit to generate a voltage regulation signal, which is fed back to the boost unit for regulating the size of the AC working voltage and accordingly controlling the brightness of the EL panel.

### FIELD OF THE INVENTION

The present invention relates to an electroluminescent (EL) backlight driving circuit, and more particularly to a driving circuit for driving an EL panel to emit light for use as a backlight source of a display.

### BACKGROUND OF THE INVENTION

Most of various currently available high-tech products, such as computer display screens, tablet television sets, mobile phones, cameras and digital photo frames, have adopted a liquid crystal display (LCD) as a human-machine interface. All the LCD displays require backlight to show the screen.

Currently, among others, cold cathode fluorescent lamp (CCFL) and light emitting diode (LED) are the most common backlight sources. A new trend of the backlight source is an electroluminescent (EL) panel, which is an area light source providing more uniform light than the linear light source of the CCFL and the point light source of the LED. The light from the EL panel is soft and not glaring. What is most important is the EL panel does not produce heat, has low power consumption, and is ultra-thin and elastic to enable wider applications than the CCFL and LED. Further, the EL panel is environment-friendly and requires lower manufacturing cost than the LED. Therefore, the EL panel has very good competing potential in the market.

Generally speaking, it is not difficult to drive the EL panel to emit light. The EL panel can be driven to emit light so long as a working voltage ranged between 50 and 250 Vrms, a working frequency about 1 KHz, and an output current about 0.14 mA/cm² are output to the EL panel. However, to use the EL panel as the backlight source of a display device, it is not only necessary to drive the EL panel to emit light, but also give the EL panel with a protection function to meet related safety codes. The EL panel must also be compatible with the software or firmware currently used by the LCD display, and have the functions of controlling the on/off and adjusting the brightness thereof. Therefore, it is the most important issue to design a driving circuit for stably controlling and driving the EL panel to emit light, so that the EL panel can be more popularly applied in the display devices to serve as a backlight source.

### SUMMARY OF THE INVENTION

A primary object of the present invention is to provide an EL backlight driving circuit that is compatible with the control software and firmware as well as the power supply, on/off and brightness control signals of the current display for driving an EL panel to emit light, so that the EL panel can be popularly applied in the display devices to serve as a backlight source thereof

To achieve the above and other objects, the EL backlight driving circuit according to the present invention includes a power on/off unit electrically connected to a DC voltage of a display device and controlled by an ON signal of the display to output the DC voltage as a working voltage; a boost unit electrically connected to the working voltage of the power on/off unit for boosting and converting the working voltage into a modulation working voltage; a resonance unit electrically connected to the modulation working voltage of the boost unit and controlled by the ON signal of the display for oscillating the modulation working voltage to generate and output an AC working voltage to drive an electroluminescent (EL) panel to emit light; and a voltage feedback unit for comparing an output feedback voltage of the resonance unit with a brightness signal of the display and then comparing the amplified output feedback voltage with a feedback control voltage of the boost unit to generate a voltage regulation signal, which is fed back to the boost unit for regulating the size of the modulation working voltage and accordingly the size of the AC working voltage to thereby control the brightness of the EL panel. Therefore, the EL panel can maintain stable brightness and have prolonged service life.

To achieve the above and other objects, the EL backlight driving circuit according to the present invention further includes a protection unit, which includes an over-voltage protection circuit electrically connected to the AC working voltage of the resonance unit for detecting whether the AC working voltage exceeds a preset high-threshold voltage; and the protection unit outputs an OFF signal to the resonance unit when the AC working voltage is detected as being higher than the preset high-threshold voltage, so as to stop the resonance unit from oscillating.

To achieve the above and other objects, the protection unit in the EL backlight driving circuit of the present invention further includes an open lamp protection circuit for detecting whether the AC working voltage is lower than a preset low-threshold voltage, and the protection unit outputs the OFF signal to the resonance unit when the AC working voltage is detected as being lower than the low-threshold voltage, so as to stop the resonance unit from oscillating. And, the protection unit further includes a time-delay circuit for delaying the detection by the open lamp protection circuit, so that the OFF signal is not generated when an under-voltage condition occurs at booting and normal booting can be ensured.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the EL backlight driving circuit according to the present invention;

FIG. 2 is a circuit diagram of an embodiment of the power on/off unit shown in FIG. 1;

FIG. 3 is a circuit diagram of an embodiment of the boost unit shown in FIG. 1;

FIG. 4 is a circuit diagram of an embodiment of the resonance unit shown in FIG. 1;

FIG. 5 is a circuit diagram of an embodiment of the voltage feedback unit shown in FIG. 1; and

FIG. 6 is a circuit diagram of an embodiment of the protection unit shown in FIG. 1.

### DETAILED DESCRIPTION OF THE PREFERRED EMBODIMENTS

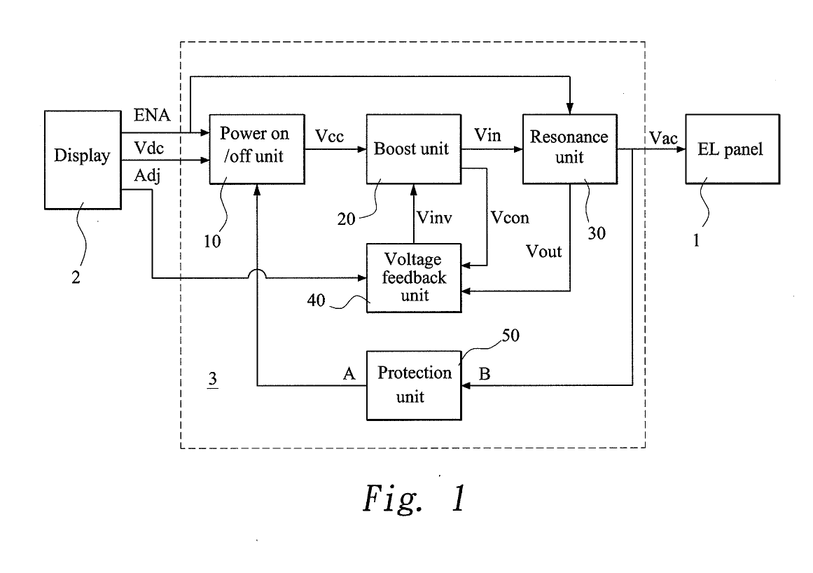

Please refer to FIG. 1 that is a block diagram of an electroluminescent (EL) backlight driving circuit 3 according to the present invention for driving an electroluminescent (EL) panel 1, so that the EL panel 1 can serve as a backlight source for a display 2. Preferably, the display is a liquid crystal display (LCD display). The EL backlight driving circuit 3 of the present invention is compatible with and can be connected to a control circuit of the display 2 to receive at least one set of power and control signals, including, such as, a direct-current (DC) voltage (Vdc), an on/off signal (ENA), a brightness signal (Adj), etc. generated by the display 2.

The EL backlight driving circuit 3 of the present invention includes a power on/off unit 10, a boost unit 20, a resonance unit 30, a voltage feedback unit 40, and a protection unit 50. The on/off signal (ENA) generated by the display 2 includes an ON signal and an OFF signal. Preferably, the ON signal is a high-level voltage (high) and the OFF signal is a low-level voltage (low).

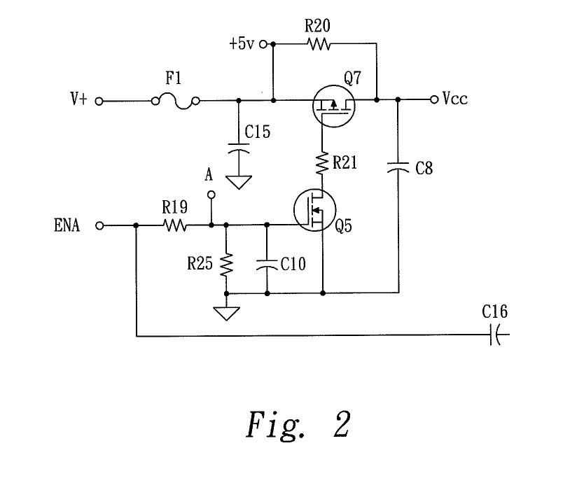

Please refer to FIG. 2 that is a circuit diagram of an embodiment of the power on/off unit 10. As shown, the power on/off unit 10 is a switching circuit mainly including two transistors Q5, Q7. The power on/off unit 10 is electrically connected to the DC voltage (Vdc) of the display 2, and is controlled by the on/off signal (ENA) generated by the display 2. When the ENA signal is high, it is the ON signal, so that the transistors Q5 and Q7 are saturated and turned on, and the DC voltage (Vdc) is output as a working voltage (Vcc); and on the other hand, when the ENA signal is low, the transistors Q5 and Q7 are cut off without producing any working voltage. In this manner, it is able to control the on/off of the driving circuit 3 via voltage control.

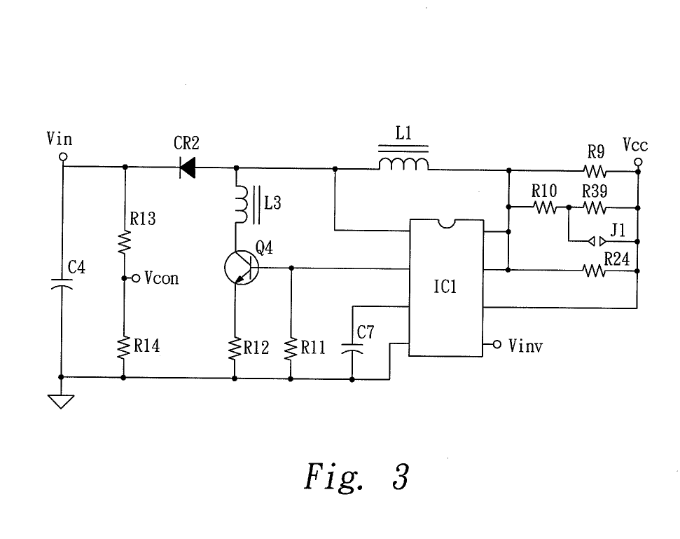

Please refer to FIG. 3 that is a circuit diagram of an embodiment of the boost unit 20. As shown, the boost unit 20 is a boost circuit that uses a pulse width modulation integrated circuit (PWM IC) to generate a high-frequency PWM signal, and uses an inductor L1 as an energy-storage element, which is electrically connected to the working voltage (Vcc) of the power on/off unit 10 and works with a transistor Q4 to form a boost circuit for voltage superposition. When the PWM signal is at a pulse on time, the transistor Q4 is saturated and turned on, so that the working voltage (Vcc) can be stored at the inductor L1; and when the PWM signal is at a pulse off time, the transistor Q4 is cut off and the output voltage is equal to a superposed voltage of the working voltage (Vcc) and the energy-storing voltage of the inductor L1, that is, Vin=Vcc+VL1 to form a boost effect.

Since the energy-storing voltage size of the Inductor L1 is determined by the pulse on width (time), the output voltage is also a modulation working voltage (Vin) boosted from the working voltage (Vcc). Meanwhile, since the pulse on width is also controlled by a voltage regulation signal (Vinv) of the voltage feedback unit 40, the size of the modulation voltage value can also be controlled by the voltage regulation signal (Vinv).

The output modulation working voltage (Vin) is further divided by two resistors R13 and R14 to generate a feedback control voltage (Vcon) to the voltage feedback unit 40 for voltage comparison, from which the voltage regulation signal (Vinv) is obtained.

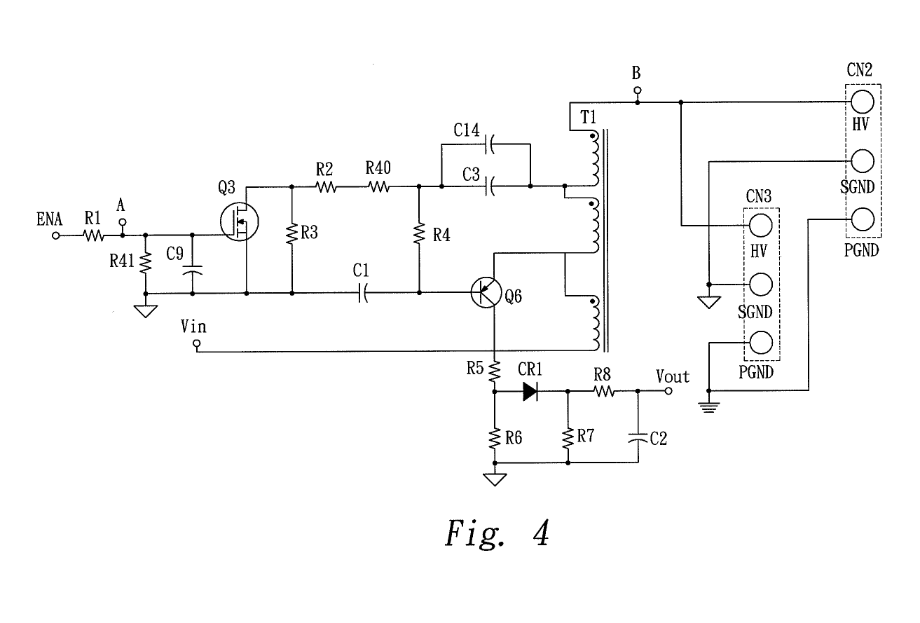

Please refer to FIG. 4 that is a circuit diagram of an embodiment of the resonance unit 30. As shown, the resonance unit 30 is a DC to AC circuit, in which a transformer T1 and two parallelly connected capacitors C3 and C14 (hereinafter together referred to as the capacitor C) together form an LC resonance oscillation circuit, which is electrically connected to the modulation working voltage (Vin) of the boost unit 20 and to the on/off signal (ENA), and can be controlled by the ON signal of the ENA signal to oscillate the direct current (DC) modulation working voltage (Vin) to generate an alternating current (AC) working voltage (Vac).

The circuit operation of the resonance unit 30 is now described with reference to FIG. 4. When the on/off signal (ENA) is high or an ON signal, the transistor Q3 is turned on, the modulation working voltage (Vin) charges the capacitor C, and a middle winding inductor (hereinafter referred to as the inductor L) of the transformer T1 discharges. When the capacitor C has a charging voltage Vc equal to the modulation working voltage (Vin), the transistor Q6 is forward biased and turned on, the capacitor C discharges, and the inductor L is charged. When the capacitor C fully discharges, the capacitor and the voltage change state, the inductor L discharges to the capacitor C. When the capacitor C has a charging voltage Vc equal to a negative modulation working voltage (Vin), the transistor Q6 is cut off, the modulation working voltage (Vin) charges the inductor L again. The above operation cycles to form LC resonance and generate an AC working voltage, which is output to drive the EL panel to emit light. The LC resonance continues until the on/off signal (ENA) is low or the OFF signal.

Further, through the on/off of the transistor Q6, an output feedback voltage (Vout) can be generated to the voltage feedback unit 40 for comparison and to serve as a basis of regulating the size of the AC working voltage.

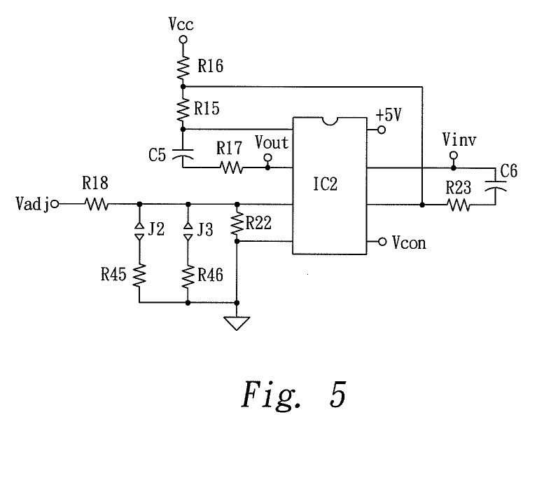

Please refer to FIG. 5 that is a circuit diagram of an embodiment of the voltage feedback unit 40. As shown, the voltage feedback unit 40 is electrically connected to the feedback control voltage (Vcon) of the boost unit 20 and to the output feedback voltage (Vout) of the resonance unit 30, and includes a voltage amplification and comparison IC. The voltage amplification and comparison IC compares the output feedback voltage (Vout) with the brightness signal (Adj) of the display 2, amplifies the output feedback voltage (Vout), and then compares the amplified output feedback voltage (Vout) with the feedback control voltage (Vcon) to generate the voltage regulation signal (Vinv), which is fed back to the boost unit 20 for regulating the voltage size of the modulation working voltage (Vin) and accordingly, regulating the voltage size of the AC working voltage. The AC working voltage drives the EL panel 1 to emit light. Therefore, the size of the AC working voltage controls the brightness of the EL panel 1.

The EL panel generally has the drawback of optical attenuation. That is, the brightness of the EL panel will reduce when the EL panel has been used over a long time. However, the voltage feedback unit 40 in the EL backlight driving circuit according to the present invention can change the output voltage regulation signal (Vinv) according to actual changes in the brightness of the EL panel, so as to regulate the size of the modulation working voltage (Vin), allowing the EL panel to maintain stable brightness and have prolonged service life.

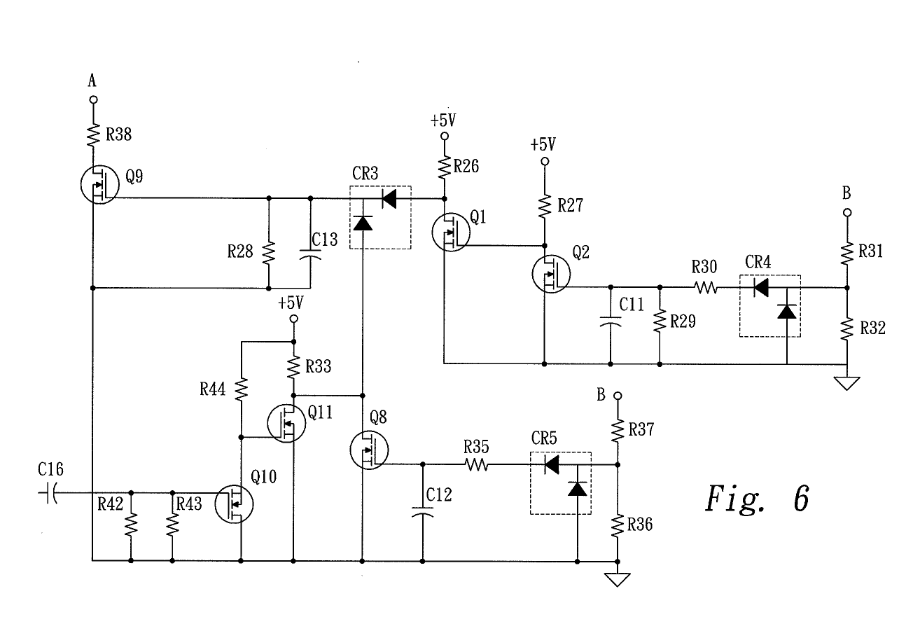

Please refer to FIG. 6 that is a circuit diagram of an embodiment of the protection unit 50. The protection unit 50 includes an over-voltage protection circuit and an open-lamp protection circuit, and is electrically connected to the AC working voltage (Vac) of the resonance unit 30. With the protection unit 50, the AC working voltage (Vac) for driving the EL panel 1 is protected against over- or under-voltage.

The over-voltage protection circuit is shown at the upper part of FIG. 6. The over-voltage protection circuit includes two transistors Q1 and Q2 that together form a detection circuit for detecting a preset high-threshold voltage, and a transistor Q9 that forms a protection switch. The AC working voltage (Vac) is input at point B and divided by two resistors R31 and R32. When the AC working voltage (Vac) is higher than the high-threshold voltage, the transistor Q2 is turned on and the transistor Q1 is cut off, so that the transistor Q9 is turned on and the voltage at an output point A is low, and the point A is connected to the on/off signal (ENA) to form the OFF signal for stopping the resonance unit 30 from oscillating to achieve the purpose of voltage protection.

The open lamp protection circuit is shown at the lower part of FIG. 6. The open lamp protection circuit includes a transistor Q8 that forms a detection circuit for detecting a preset low-threshold voltage. The AC working voltage (Vac) is input at point B and divided by two resistors R37 and R36. When the AC working voltage (Vac) is lower than the low-threshold voltage, the transistor Q8 is cut off and the transistor Q9 is turned on, so that the voltage at the output point A is low, and the point A is connected to the on/off signal (ENA) to form the OFF signal for stopping the resonance unit 30 from oscillating to achieve the purpose of voltage protection.

However, the condition of under-voltage would also occur during booting. Therefore, the protection unit 50 uses a set of transistors Q10 and Q11 and a capacitor C16 and a resistor R42 to form a time-delay circuit for delaying the detection by the open lamp protection circuit. When booting, the transistors Q11 and Q10 will be temporarily turned on to bypass the cutoff of the transistor Q8, so that the transistor Q9 is cut off, and the point A is connected to the on/off signal (ENA) to keep the ON signal until the booting is completed. Thus, the condition of generating the OFF signal due to the under-voltage at booting can be avoided to ensure normal booting.

What is claimed is:

1. An electroluminescent (EL) backlight driving circuit for driving an electroluminescent (EL) panel to emit light and serve as a backlight module for a display device, the display device being able to generate at least a DC voltage (Vdc), an on/off signal (ENA), and a brightness signal (Adj); the EL backlight driving circuit comprising:
a power on/off unit being a power on/off circuit electrically connected to the DC voltage (Vdc) of the display device and controlled by an ON signal of the on/off signal (ENA) to output the DC voltage (Vdc) as a working voltage (Vcc);
a boost unit being a boost circuit electrically connected to the working voltage (Vcc) of the power on/off unit for boosting and converting the working voltage into a modulation working voltage (Vin); the boost unit being able to modulate voltage size and controlled by a voltage regulation signal (Vinv) to generate a feedback control voltage (Vcon);
a resonance unit being a DC to AC circuit electrically connected to the modulation working voltage (Vin) of the boost unit and to the on/off signal (ENA), and controlled by the ON signal of the on/off signal (ENA) to oscillate the DC modulation working voltage (Vin) and thereby generate an AC working voltage (Vac), which is output to drive the EL panel to emit light; and the resonance unit generating an output feedback voltage (Vout); and
a voltage feedback unit being electrically connected to the feedback control voltage (Vcon) of the boost unit and the output feedback voltage (Vout) of the resonance unit for comparing the output feedback voltage (Vout) with the brightness signal (Adj) and then amplifying and comparing the output feedback voltage (vout) with the feedback control voltage (Vcon) to generate the voltage regulation signal (Vinv), which is fed back to the boost unit for regulating the size of the modulation working voltage (Vin) and accordingly the size of the AC working voltage (Vac) to control the brightness of the EL panel.

2. The EL backlight driving circuit as claimed in claim 1, wherein the display device is an LCD display.

3. The EL backlight driving circuit as claimed in claim 1, wherein the on/off signal (ENA) generated by the display device includes an ON signal and an OFF signal, and the ON signal being a high-level voltage and the OFF signal being a low-level voltage.

4. The EL backlight driving circuit as claimed in claim 1, further comprising a protection unit, the protection unit including an over-voltage protection circuit electrically connected to the AC working voltage (Vac) of the resonance unit for detecting whether the AC working voltage (Vac) exceeds a preset high-threshold voltage; and an OFF signal of the on/off signal (ENA) is output to the resonance unit when the AC working voltage (Vac) is detected as being higher than the preset high-threshold voltage, so as to stop the resonance unit from oscillating.

5. The EL backlight driving circuit as claimed in claim 4, wherein the protection unit includes an open lamp protection circuit for detecting whether the AC working voltage (Vac) is lower than a preset low-threshold voltage, and the OFF signal of the on/off signal (ENA) is output to the resonance unit when the AC working voltage (Vac) is detected as being lower than the low-threshold voltage, so as to stop the resonance unit from oscillating.

6. The EL backlight driving circuit as claimed in claim 5, wherein the protection unit further includes a time-delay circuit for delaying the detection by the open lamp protection circuit, so that the OFF signal is not generated when an under-voltage condition occurs at booting and normal booting can be ensured.

7. The EL backlight driving circuit as claimed in claim 1, wherein the boost unit uses a PWM IC to generate a high-frequency PWM signal, enabling storage of the working voltage (Vcc) at pulse on time and output of superposed working voltage (Vcc) and energy-storing voltage at pulse off time; that is, the working voltage (Vcc) is boosted to generate the modulation working voltage (Vin), and the size of boosting is determined by a pulse on width while the pulse on width is controlled by the voltage regulation signal (Vinv).

8. The EL backlight driving circuit as claimed in claim 1, wherein the resonance unit uses a transformer and at least one capacitor to generate LC resonance oscillation for oscillating the modulation working voltage (Vin) to generate the AC working voltage (Vac), which is output to drive the EL panel to emit light.
